(19) United States
(12) Patent Application Publication
(10) Pub. No.: US 2026/0100094 A1
(43) Pub. Date: Apr. 9, 2026

(54) PROGRESSIVE GAMING SYSTEM AND METHOD PROVIDING OPERATOR-CONFIGURABLE RESET VALUE

(71) Applicant: Incredible Technologies, Inc., Vernon Hills, IL (US)

(72) Inventor: David Kamner, Lake in the Hills, IL (US)

(21) Appl. No.: 19/352,096

(22) Filed: Oct. 7, 2025

Related U.S. Application Data
(60) Provisional application No. 63/704,787, filed on Oct. 8, 2024.

(51) Int. Cl. G07F 17/32

(52) U.S. Cl. CPC G07F 17/3227; G07F 17/3258

(57) ABSTRACT

A progressive gaming system includes an electronic gaming machine having a progressive controller. The progressive controller is configured to enable an operator to adjust and set a progressive reset value in predetermined increments on the electronic gaming machine. The progressive reset value is adjusted, and the electronic gaming machine maintains a return to player (RTP) percentage at a set value. The odds of winning a progressive award on a paid spin are set according to:

$$O = \frac{B * G}{R}$$

where:
O is the odds of winning a progressive award on a paid spin,
B is a current bet in cash,
G is the RTP percentage, and
R is the progressive reset value in cash.

### CROSS-REFERENCE TO RELATED APPLICATION DATA

This application claims the benefit of and priority to Provisional U.S. Patent Application Ser. No. 63/704,787, filed Oct. 8, 2024, titled PROGRESSIVE GAMING SYSTEM AND METHOD PROVIDING OPERATOR-CONFIGURABLE RESET VALUE, the disclosure of which is incorporated herein in its entirety.

### FIELD

Embodiments presented herein are directed generally to electronic gaming systems and methods, and more particularly to systems and methods for providing a progressive gambling game having an operator-configurable reset value.

### BACKGROUND

Gaming systems for providing progressive-style prizes or jackpots are widely known. A progressive prize or jackpot is generally one that can gradually increase based on wagering games played at gaming machines that are included in an associated network and designated for participation with the progressive prize or jackpot. In many cases such progressive awards can be provided via wide area networks (WAN) and/or local area networks (LAN). WAN systems can enable operators to provide progressive awards for gaming machines located at different gaming establishments/venues, whereas LAN systems can be utilized for providing progressive awards at a plurality of gaming machines at the same gaming location (e.g., across a bank or banks of gaming machines at the same casino).

Traditionally, systems for providing progressive jackpots have been limited to gaming machines for the same gambling game (a single family of games). One reason for such limitation is that different games can have different odds to win prizes and different return to player (RTP) ratios. Generally, a game is designed to return a certain percentage of the amount wagered back to a player over the course of many plays or instances of the game, which is generally referred to as the RTP. The RTP and randomness of a random number generator ensure the fairness of games and are highly regulated. One challenge with synchronizing different types or families of games into a shared progressive system is maintaining the RTP ratios for the different games.

Traditional progressive gaming systems also do not provide a gaming operator with flexibility in adjusting the reset value of progressive jackpots (the reset value being the value of cash that a progressive jackpot is set to after a progressive prize is awarded). Thus, when an operator of a casino wants to offer a progressive game with a different reset value from a current game, an entirely different version of the game needs to be developed with modified paytables and math models in order to reliably maintain the RTP ratio. Since gaming is a highly regulated industry, new versions of a game and game software usually need to be submitted for and to obtain regulatory approval, which can delay delivery and use of such games. Thus, the development and implementation of progressive games with customized reset values can be costly and time consuming.

Accordingly, there is a need for the ability of a gaming system operator to adjust and reset the value of progressive game jackpots without modifying paytables or math models and to do so while reliably maintaining the RTP ratio.

### SUMMARY

In an aspect, a progressive gaming system includes an electronic gaming machine having a progressive controller. The progressive controller is configured to enable an operator to adjust and set a progressive reset value in predetermined increments on the electronic gaming machine. The progressive reset value is adjusted, and the electronic gaming machine maintains a return to player (RTP) percentage at a set value. The odds of winning a progressive award on a paid spin are set according to:

$$O = \frac{B * G}{R}$$

where:
O is the odds of winning a progressive award on a paid spin,
B is a current bet in cash,
G is the RTP percentage, and
R is the progressive reset value in cash.

In embodiments, the system includes a second electronic gaming machine. The second electronic gaming machine is in communication with the progressive controller, and the progressive controller is configured to enable an operator to adjust and set a second progressive reset value for the second electronic gaming machine in predetermined increments on the second electronic gaming machine.

In embodiments, the first electronic gaming machine and the second electronic gaming machine are a same type of electronic gaming machine. Alternately, the first electronic gaming machine and the second electronic gaming machine are different types of electronic gaming machines.

In embodiments, the progressive controller communicates with the second electronic gaming machine over a local area network. The controller can communicate with the second electronic gaming machine over a wide area network.

The system can include multiple further electronic gaming machines, in which the first and second and multiple further electronic gaming machines define a family of electronic gaming machines. In embodiments, the progressive controller is configured to enable an operator to adjust and set different progressive reset values in predetermined increments on each of the family of electronic gaming machines.

The predetermined increments can be, for example, $500, and a range of the reset values can be, for example, between $4,000 and $210,000.

In an aspect, a method for adjusting a progressive reset value in an electronic gaming machine having a progressive controller, includes selecting a progressive reset value, inputting the selected reset value in the progressive controller, and communicating the selected reset value to the electronic gaming machine. In methods, when the progressive reset value is adjusted, the electronic gaming machine maintains a return to player (RTP) percentage at a set value, and the odds of winning a progressive award on a paid spin are set according to:

$$O = \frac{B * G}{R}$$

where:
O is the odds of winning a progressive award on a paid spin,
B is a current bet in cash,
G is the RTP percentage, and
R is the progressive reset value in cash.

In methods, the predetermined increments are, for example, $500, and the range of the reset values between $4,000 and $210,000.

These and other objects, features and advantages of the present disclosure will be apparent from the following detailed description taken in conjunction with the accompanying drawings, and in conjunction with the appended claims.

### DESCRIPTION OF THE DRAWINGS

The benefits and advantages of the present disclosure will become more readily apparent to those of ordinary skill in the relevant art after revieing the following detailed description and accompanying drawings, in which:

FIG. 1 is a schematic block diagram of a representative architecture for an electronic gaming device; and

FIG. 2 illustrates an example of a network of electronic gaming machines (EGMs).

### DETAILED DESCRIPTION

While elements disclosed herein are susceptible of embodiment in many different forms, representative embodiments will be described herein in specific detail with the understanding that the present disclosure is to be considered as an exemplification of the principles of the invention and is not intended to limit the invention to the specific embodiments illustrated.

According to embodiments presented herein, a progressive-style gaming system and method is provided that has the capability to enable an operator to adjust and set the progressive reset value in predetermined increments (e.g. increments of $500 but within the limit or maximum threshold of the respective jurisdiction where the games are offered). In preferred embodiments, the range in which the reset value can be configured to be set between $4,000 and $210,000 at minimum bet/wager amount (currently the maximum amount under U.S. state law to offer a progressive game having odds between 1 and 100 m at a $0.60 minimum bet).

In configuring a progressive game for play, the system can adjust the odds to award a progressive prize based upon the configured reset value and the amount of a particular wager. The implementation of such technical approach can enable games of multiple games families to automatically adjust such that RTP ratios are maintained relative to the configured reset value of the progressive. Thus, games from multiple game families on a network can be synchronized to provide the same progressive awards and can provide the same odds to award progressive prizes relative to the amounts wagered. The capability to provide an operator-adjustable reset value in accordance herewith can also eliminate the need to develop and install new game software utilizing different paytables to maintain RTP in progressive games. Conventionally, a change to the progressive reset value necessitated a change of the game software and the utilization of a different paytable, including resetting the game and clearing the game memory. Embodiments presented herein provide the ability to dynamically adjust the odds of award outcomes to maintain RTP based upon a change to the reset value. Thus, while the reset value was once a constant, hard-coded numerical designation, embodiments presented herein provide for variable adjustment of such the reset value with corresponding automatic adjustments to the game math to maintain the RTP value.

According to embodiments presented herein, the wager and reset value determine the odds for winning outcomes and eligibility for progressive games and awards is determined when the game is put on the network (WAN or LAN), prior to the time a wager is made.

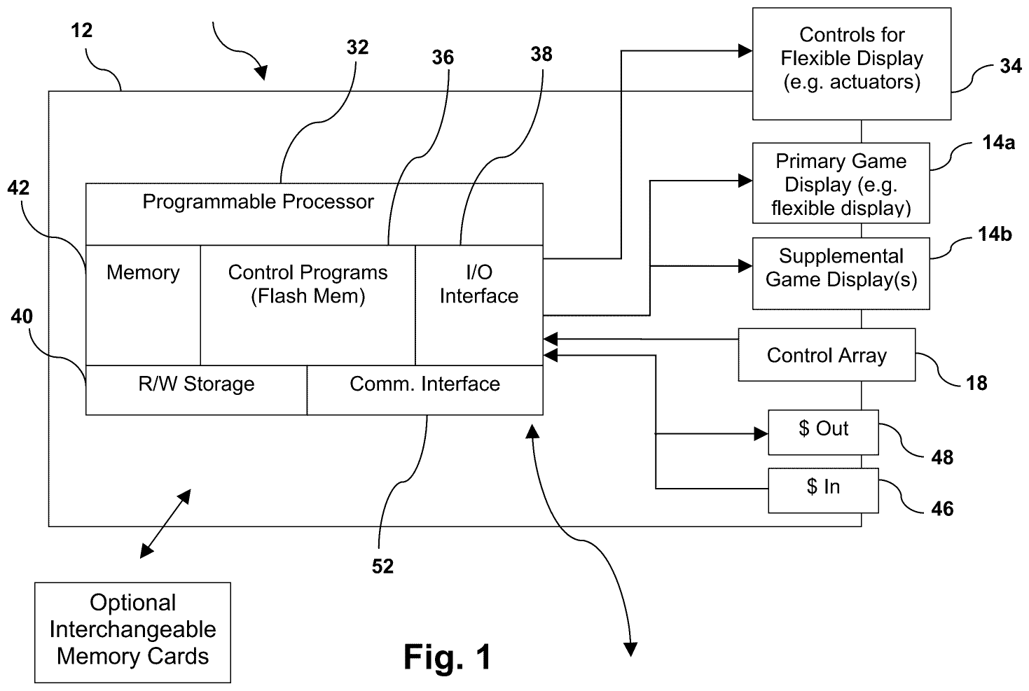

Referring now to FIG. 1 there is shown is a schematic block diagram of a representative architecture for an electronic gaming device 10. The illustrated block diagram is of an exemplary architecture for an electronic gaming machine (“EGM”) 10. As shown schematically in FIG. 4, the EGM 10 can include a control unit 32 including, for example, a programmable processor (such as for example a microprocessor or microcontroller) operatively coupled to one or more game displays 14a, 14b. The control unit 32 can include associated control circuitry and be operatively connected to an interface 38 with input/output circuits and at least one storage unit 40 which can store a plurality of computer readable instructions executable by control unit 32. The EGM 10 can also include memory 42 which can include a main memory containing dynamic information processed by processor 32 and/or a static memory which can contain fixed information, such as, for example, an operating system, game programs, and a configuration of information necessary for the control unit 32 to register and execute input from a player through control array 18. Such components can be housed and/or secured within cabinet 12.

The control unit 32 can execute control programs 36 to control movement of the flexible display panel 14 as described above and to carry out primary functions for play of the game. For example, control unit 32, control programs 36 and associated circuitry can process game input, operations and events and instruct signals to be transmitted to the controls or actuators 34 to move, adjust or extend into predetermined positions associated with corresponding shapes of the flexible display 14a.

Additional primary functions carried out by control unit 32 can include, for example, processing input commands and signals associated with the deposit of credits, randomly selecting game outcomes from a plurality of possible outcomes, recognizing a particular outcome as a predetermined winning or non-winning outcome and/or determining a reward, such as a progressive award amount associated with a particular winning outcome. The control unit 32, which can be a progressive control unit or progressive controller, can additionally control the game displays 14a, 14b by generating static or dynamic video for presentation thereon.

The control unit can, as described herein, permit an operator (an authorized operator or technician, and not a player), on a progressive EGM 10, to configure the progressive game reset value. More particularly, one of the gaming terminals coupled to the network can be designated and configured as a progressive and can present operator settings menu(s) that can be accessed via a key switch or service button to enable the operator to configure the reset value when the gaming terminal is out of session.

The player control array 18 can include one or more input devices, such as for example, a keyboard, mechanical lever, a touch-screen, push buttons or pads and/or any other means for control, or desired combination of controls, able to accept input from a player and produce output to the game display 14a, 14b in response to a player's input. Displays 14a, 14b can include the flexible display screen as described above in more detail and any supplemental or additional conventional electronic display device suitable for electronically presenting graphics or images associated with a game played on the EGM 10, or other information such as advertising/promotional content.

Where embodiments of the present disclosure are practiced or provided in connection with a wagering game, the gaming device 10 can further include a credit input device 46, such as for example a coin or bill acceptor or card reader and a payout device 48. The credit input device 46 and payout device 48 can be operatively connected to the control unit 32 and when money or other credits are deposited in connection with a game, the control program 36 can instruct the payout device 48 to issue an award in response to the selection of certain predetermined winning outcomes of the game. The reward or payoff can be provided in any form, including for example, coins, bills, credits, points, cards, tickets, or coupons.

The gaming device 10 can additionally feature communication means for electrically transmitting signals, including control signals, game data or detected conditions to a remote electronic device such as for example, a computer, network or display device, dedicated storage device, or other mobile electronic device such as a PDA, smart phone, notebook computer or electronic tablet. Such communication means can include, for example, a communication interface 52 that can connect the EGM 10 to external electronic devices via wired or wireless communication.

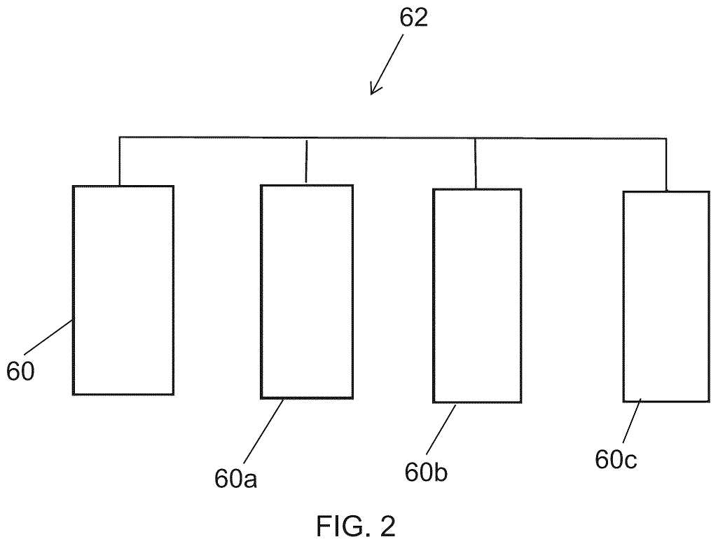

Referring to FIG. 2, a network 62 of EGMS 60, 60a . . . c for providing the progressive system and method is shown. As to the reset value aspect for a progressive EGM, by way of example, a specific machine or gaming terminal 60 on the network 62 can be designated as a progressive controller and information regarding the progressive reset value can be stored on the machine 60 and communicated to the other machines 60a . . . c on the network. Thus, upon connecting a gaming terminal to the network, the progressive controller 60 can identify and make a determination as to gaming machines eligible for progressive awards and the individual gaming terminals or machine 60a, 60b, 60c can receive the reset value from the progressive controller 60 and store such value locally thereon. With the reset value being stored locally by machines 60a, 60b, 60c, upon a wager being placed on such machine, the respective machine will be able to automatically adjust the odds of winning outcomes based on the reset value and the wager information. Thus, the odds for triggering awarding winning outcomes can change be configured to change and update in real-time or near real-time without the need to implement new software with a different reset value and different paytable.

The game can rely on the configured reset value from the progressive controller and the current wager made at a gaming terminal to set the odds to award progressive prizes while maintaining the overall RTP for the game. Thus, when the progressive reset value is increased the odds to win a progressive award can decrease resulting in a lower likelihood/probability of achieving an outcome associated with a progressive award (and thus from a probability perspective it should take longer for the progressive award outcome to occur). Accordingly, the odds to win the progressive award are adjusted to maintain the same RTP ratio for the game where the wager was placed.

For example, where the reset value is set by an operator to five thousand dollars ($5,000), and a player makes a wager in an amount of ten dollars ($10), the system can adjust the odds to win the progressive jackpot to 1 in 142,857.1 spins. Where the reset value is set by an operator to twenty thousand dollars ($20,000), and a player makes wager in an amount of twenty dollars ($20), the system can adjust the odds to win the progressive jackpot to 1 in 285,714.3 spins. In either case, the RTP ratio is maintained. More particularly, a model for establishing the odds can be represented as the product of the amount of a wager in cash and the goal RTP divided by the set reset value in cash.

Thus, expressed mathematically:

$$Odds of winning a progressive award on a paid spin = \frac{( current bet in cash ) * ( goal RTP )}{( reset value in cash )} or$$

$$O = ( B * G ) / R ,$$

where:
O is the odds of winning a progressive award on a paid spin,
B is the current bet in cash,
G is the goal return to player (RTP),
R is the reset value in cash.

Where a progressive award is won, information regarding such award can be communicated to the progressive controller which can determine whether the progressive reset value should be implemented, and where a determination is made to implement the reset value, the system can set the progressive jackpot amount to the configured reset value. Thus, upon a progressive award being triggered, the system can award the player the value of designated reset value plus the growth contributed from play on the respective games. Once the progressive award is triggered, the award can be reset to the respectively assigned reset value.

Advantageously, the present system permits an operator to adjust the reset value on one or more machines, for example 60, 60a, 60b, 60c and permits the operator to adjust the reset value on the more than one machine 60, 60a, 60b, 60c simultaneously and further permits the operator to adjust the reset value simultaneously on different types and/or families of machines. In any event, when the reset value is adjusted, each game adjusts so that the RTP is maintained regardless of the adjusted reset value. When a reset value is adjusted, that reset value is adjusted when the game is put on the network 62, with the odds for winning award outcomes being determined at the time a wager is made at the individual game based on the reset value.

In application, an operator sets the reset value at the progressive controller 32. Information regarding the reset value is communicated to the progressive machines, for example, machines 60, 60a, 60b, 60c on the network 62. At the time that a wager is made, the individual machines 60, 60a, 60b, 60c on the network 62 will calculate the odds of winning a progressive award on any one paid spin based on the wager and reset value while maintaining the RTP.

Methods for adjusting a progressive reset value in an electronic gaming machine, which electronic gaming machine has a progressive controller 32, include selecting a progressive reset value, inputting the selected reset value in the progressive controller 32, and communicating the selected reset value to the electronic gaming machine(s) 60, 60a, 60b, 60c.

When the progressive reset value is adjusted, the electronic gaming machine(s) 60, 60a, 60b, 60c maintain(s) a return to player (RTP) percentage or respective RTP percentages at a set value(s), and the odds of winning a progressive award on a paid spin on that machine 60, and/or 60a, and/or 60b, and/or 60c is set according to:

$$O = \frac{B * G}{R}$$

where:
O is the odds of winning a progressive award on a paid spin,
B is a current bet in cash,
G is the RTP percentage, and
R is the progressive reset value in cash.

In methods according to embodiments presented herein, the predetermined increments can be, for example $500. Of course, other increments can be used. In addition, in methods, a range of the reset values between $4,000 and $210,000. Here too, other ranges of reset values can be used.

It is understood that the features from any of the embodiments described herein may be combined with, or replace features of other embodiments described herein, without deviating from the scope of this disclosure.

In the present disclosure, the words “a” or “an” are to be taken to include both the singular and the plural. Conversely, any reference to plural items shall, where appropriate, include the singular.

All patents referred to herein are hereby incorporated herein by reference, whether or not specifically done so within the text of this disclosure.

Further, logic flows referenced herein do not require the particular sequential order in which they are described to achieve the preferred objectives, benefits, and results. Other steps may be provided, or steps may be eliminated, from the described flows, and other components may be added to, or removed from the described embodiments.

From the foregoing, it will be observed that numerous variations and modifications may be affected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed is:

1. A progressive gaming system, comprising:
an electronic gaming machine, the electronic gaming machine having a progressive controller, the progressive controller configured to enable an operator to adjust and set a progressive reset value in predetermined increments on the electronic gaming machine,
wherein the progressive reset value is adjusted and wherein the electronic gaming machine maintains a return to player (RTP) percentage at a set value, and wherein the odds of winning a progressive award on a paid spin is set according to:
$$O = \frac{B * G}{R}$$
where:
O is the odds of winning a progressive award on a paid spin,
B is a current bet in cash,
G is the RTP percentage, and
R is the progressive reset value in cash.

2. The progressive gaming system of claim 1 including a second electronic gaming machine, wherein the second electronic gaming machine is in communication with the progressive controller, and wherein the progressive controller is configured to enable an operator to adjust and set a second progressive reset value in predetermined increments on the second electronic gaming machine.

3. The progressive gaming system of claim 2, wherein the first electronic gaming machine and the second electronic gaming machine are a same type of electronic gaming machine.

4. The progressive gaming system of claim 2, wherein the first electronic gaming machine and the second electronic gaming machine are different types of electronic gaming machines.

5. The progressive gaming system of claim 2, wherein the progressive controller communicates with the second electronic gaming machine over a local area network.

6. The progressive gaming system of claim 2, wherein the progressive controller communicates with the second electronic gaming machine over a wide area network.

7. The progressive gaming system of claim 1 including multiple further electronic gaming machines, wherein the first and second and multiple further electronic gaming machines defining a family of electronic gaming machines, and wherein the progressive controller is configured to enable an operator to adjust and set different progressive reset values in predetermined increments on each of the family of electronic gaming machines.

8. The progressive gaming system of claim 1, wherein the predetermined increments are $500.

9. The progressive gaming system of claim 1 wherein a range of the reset values between $4,000 and $210,000.

10. A method for adjusting a progressive reset value in an electronic gaming machine, the electronic gaming machine having a progressive controller, comprising:
selecting a progressive reset value;
inputting the selected reset value in the progressive controller;
communicating the selected reset value to the,
wherein when the progressive reset value is adjusted and wherein the electronic gaming machine maintains a return to player (RTP) percentage at a set value, the odds of winning a progressive award on a paid spin is set according to:
$$O = \frac{B * G}{R}$$
where:
O is the odds of winning a progressive award on a paid spin,
B is a current bet in cash,
G is the RTP percentage, and
R is the progressive reset value in cash.

11. The method of claim 10, wherein the predetermined increments are $500.

12. The method of claim 10, wherein a range of the reset values between $4,000 and $210,000.
